(19) United States
(12) Patent Application Publication
(10) Pub. No.: US 2004/0199702 A1
(43) Pub. Date: Oct. 7, 2004

(54) USB communication method and computer system with USB communication line

(75) Inventor: Tsutomu Baba, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/748,746

(22) Filed: Dec. 30, 2003

(30) Foreign Application Priority Data
Jan. 6, 2003 (JP) 2003-000671

(51) Int. Cl. G06F 13/14

(52) U.S. Cl. 710/305

(57) ABSTRACT

A universal serial bus (USB) communication method includes determining in advance a communication data format between a host computer and a device driver so that a packet formed by the communication data format includes a report ID that indicates a size of the packet and transmission data, adding, at a time of transmission, the report ID indicating the size to the transmission data at a head portion of the packet and transmitting the packet with the report ID.

### BACKGROUND OF THE INVENTION

1. Field of the Invention

The present invention relates to a USB communication method for a specification of a Human Interface Device (referred to as “HID”) and a computer system provided with a USB communication line for the HID specification.

2. Description of Related Art

A universal serial bus (USB) is a communication architecture which provides a personal computer with a function to interconnect with various devices. A USB protocol can set the configuration of a device when the personal computer starts or at the time when a device or the cable of the device is inserted into the personal computer. These devices are classified into various device classes. An HID class is one of the device classes and is a device that is mainly used for a person to control operations of a computer system. A typical example of the HID class device is a pointing device such as a mouse, a track ball and a joystick, a keyboard or the like. Further, a bar-code reader, a card reader, a thermometer or the like, in which the interaction with a user is unnecessary, for example, sometimes provides data with a format similar to the HID class device.

The HID specification and the HID devices are conventionally known. When communicating based on the USB-HID specification, one byte at the head of a report used in a communication is used as a “report ID”. The “report” here means a set of data of one unit. When communicating in different-format reports with a plurality of mixed units, confusion between communications can be prevented by setting a report ID to each of the respective reports.

However, in the conventional communication based on the USB-HID specification, there may be a case that the size of data to be transmitted by one report is different for every report. Further, a short packet having a size less than the size that can be transferred as one report is mixed even when the report has the same data size. As such, control of data collection becomes complicated on the receiving side, which causes the reduction of the data processing capacity.

### SUMMARY OF THE INVENTION

In view of the problems described above, it is advantage of the present invention to provide a USB communication method for an HID specification and a computer system having a USB communication line for an HID specification by using a report ID to attain an efficient communication.

In order to achieve the above advantage, according to an embodiment of the present invention, there is provided a USB communication method between a host computer and a device driver for an HID specification including determining in advance a communication data format between the host computer and the device driver so that a packet formed by the communication data format includes a report ID that indicates a size of the packet and transmission data, and at the time of transmission, adding the report ID indicating the size to the transmission data at a head portion of the packet, and then transmitting the packet with the report ID.

In order to achieve the above advantage, according to another embodiment of the present invention, there is provided a computer system including a host computer, a device driver which is in communication with the host computer, a USB communication line for an HID specification which connects the host computer and the device driver and a communication data format which is used between the host computer and the device driver and determined so that a packet formed by the communication data format includes a report ID that indicates a size of the packet and transmission data. At the time of transmission, the report ID indicating the size is added to the transmission data at a head portion of the packet and then the packet with the report ID is transmitted.

According to the invention described above, control of data collection on a data receiving side can be simplified and the constitution of a communication report is extremely simple. Further, useless processing such as sending an empty packet and a short packet is not required and thus efficient USB communication can be performed.

In order to achieve the above advantage, according to a further embodiment of the present invention, there is provided a USB communication method between a host computer and a device driver for an HID specification including determining in advance a communication data format between the host computer and the device driver so that a packet formed by the communication data format includes a report ID that indicates a presence or an absence of a succeeding packet and transmission data, and at the time of transmission, adding the report ID indicating the presence or the absence of the succeeding packet to the transmission data at a head portion of the packet to be transmitted and then transmitting the packet with the report ID.

In order to achieve the above advantage, according to a further embodiment of the present invention, there is provided a computer system including a host computer, a device driver which is in communication with the host computer, a USB communication line for an HID specification which connects the host computer and the device driver and a communication data format which is used between the host computer and the device driver and determined so that a packet formed by the communication data format includes a report ID that indicates a presence or an absence of a succeeding packet and transmission data. At the time of transmission, the report ID indicating the presence or the absence of the succeeding packet is added to the transmission data at a head portion of the packet and the packet with the report ID is transmitted.

According to the embodiments of the invention described above, the constitution of a communication report becomes extremely simple by using the report ID which indicates the presence/absence of a succeeding packet. Therefore, useless processing such as sending an empty packet and a short packet is not required and thus efficient USB communication can be performed.

In accordance with an embodiment of the present invention, the device driver is a card reader.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1(a) is a schematic view showing an example of a data format in which a report ID is used. FIG. 1(b) is a schematic view showing an example of three packets whose report IDs are respectively set to indicate the size of each report.

FIG. 2 is a schematic block diagram showing an example of a data structure at the time of transmitting data of a plurality of packets from a host to a device in accordance with an embodiment of the present invention.

FIG. 3 is a schematic block diagram showing an example of a data structure at the time of transmitting data of a plurality of packets from the device to the host in accordance with an embodiment of the present invention.

FIG. 4 is a flow chart showing an operation example in accordance with an embodiment of the present invention.

### DETAILED DESCRIPTION OF THE PREFERRED EMBODIMENTS

A USB communication method for an HID specification and a computer system having a USB communication line for an HID specification in accordance with an embodiment of the present invention will be described below with reference to the accompanying drawings.

In the USB communication based on the HID specification, a report which assigns the report ID can set the amount of data that can be transferred by one report. Therefore, according to an embodiment of the present invention, the data length (data size) which is capable of being transferred by one report is predetermined in advance, and the report ID is determined so as to indicate the data length (data size). The settings of the report ID and the size of which the report can transfer by one report are performed during the communication of a Plug & Play (referred to as “PnP”), which is executed at the time when a personal computer which is a host and a device driver for driving a device which is a target are connected by a USB cable. The device driver is a control section integrally provided on the device side, which operates the device based on the instructions from the host side.

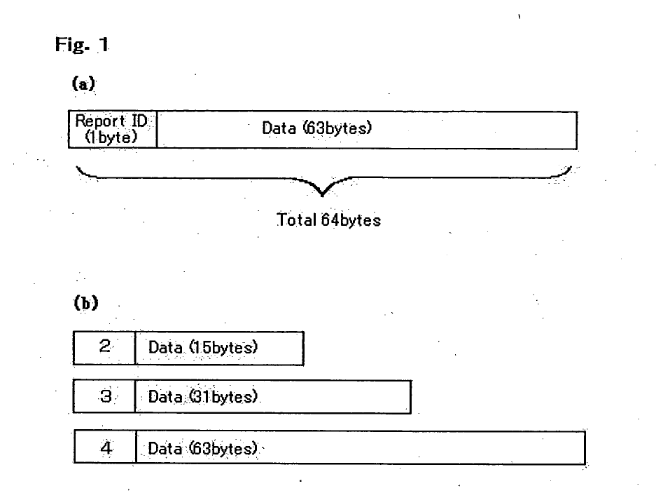

FIG. 1(a) shows a data format to which a report ID is applied in accordance with an embodiment of the present invention. The data format is an example of a data format transmitted between the host side and the device driver side. In this embodiment, the number of bytes to be used is previously considered and, for example, the number of total bytes of a maximum data length (data size) is set to be 64 bytes. The first one byte is assigned to the report ID and the remaining 63 bytes are effective data. In other words, the communication data format between the host computer and the device driver is constituted of the report ID indicating a data item and transmission data. One piece of communication data is referred to as a packet and the report ID indicates the size of a communication report (packet). A plurality of packets includes a packet having a number of the maximum length bytes and packets whose number of bytes are smaller than that of the maximum length bytes, and respective report IDs indicating the size of the packet determined in advance.

After the “PnP” operation has been executed as described above, the personal computer (host) acknowledges the correlation of the report ID and its data length and performs transmitting and receiving the data corresponding to the report ID. In other words, the packet having the number of the maximum length bytes and the packets having the number of bytes smaller than the maximum length bytes are provided, and further the respective report IDs are determined so as to coincide with the predetermined data lengths (data sizes). Therefore, the minimum sized packet that is capable of accommodating the size of the data to be transmitted can be selected from the plurality of packets of different sizes. Accordingly, a packet which has enough but the minimum data length (data size) required to transmit the data to be transmitted is selected based on the size of the data to be transmitted and the corresponding report ID is added to the data and the data is transmitted.

For example, three packets are set as follows as a concrete example as shown in FIG. 1(b).

Report ID=“2” when the data size is 16 bytes (including report ID).

Report ID=“3” when the data size is 32 bytes (including report ID).

Report ID=“4” when the data size is 64 bytes (including report ID).

As described above, the respective report IDs are determined in accordance with the data length (data size). Furthermore, the data transmission is performed in accordance with the amount of data that is going to be transmitted by using a minimum sized report which can send the data. Moreover, when the size of the transmission data is less than the size that can be transferred by one report of the selected report ID, the remaining blank portion is filled up with dummy data so as to coincide with the data length of the report and then the data is transmitted. The dummy data may be empty data or meaningless short data. Therefore, the packet which is transmitted has the data length indicated by the report ID and the receiving side can process the collection of the receiving data, which has the predetermined data length (data size), based on only the report ID as a judging indicator.

In accordance with the embodiment of the present invention, the report ID is determined so as to indicate the predetermined data length (data size). Therefore, when data is sent from the host side to the device driver side, the data length to be transmitted can be identified on the receiving side only by confirming the report ID. Accordingly, processing efficiency of received data can be enhanced and efficient communication can be performed by reducing useless processing.

In the embodiment of the present invention described above, the maximum data length is set to be 64 bytes. However, the data length larger than 64 bytes may be used as the maximum data length.

According to the settings described above, in the case that data is transmitted from a device driver to a personal computer (host), when the transmission data is transmitted by the report other than the maximum length report, in other words, when the transmission data is transmitted by the report ID of “2” or “3” other than the report ID of “4” in the above-mentioned example, the receiving process is not concluded on the personal computer (host) side. In order to avoid this case, when a report having a length other than the maximum length is transmitted conventionally, it is required that an empty packet or a short packet including data smaller than the data length which is set by the report ID is added to the data to be transmitted thereafter and then transmitted.

On the other hand, the transfer mode used in the HID specification is the mode referred to as “interrupt transfer”, which sends a packet at an interval of 1 millisecond (ms). This is required independent of the packet size. Therefore, in the case that data is transmitted from the device driver to the personal computer (host), even when the empty packet or the short packet is transmitted, it is required to put a interval of 1 ms between the packets, and thus an extra transfer time is needed. Accordingly, when the packet other than that of the maximum length is employed at the time of transmitting the data, wasting of the processing time occurs.

On the contrary, in accordance with another embodiment of the present invention, in the case that the data is transmitted from the device driver to the personal computer (host), transmission data is sent by using two reports (packets) having the same maximum length as described below, for example, 64 bytes in this embodiment. According to this embodiment of the present invention, an empty packet or a short packet is not required to be added after the packet. This communication method is preferably applied to the case that the data is transmitted from the device driver to the personal computer (host). However, the communication method may be applied to the case that the data is transmitted from the personal computer (host) to the device driver.

Concretely, two reports having the same maximum data size are set as follows.

Report ID=“0x04” and the data size is 64 bytes (including one byte report ID) when the packet is the last data

Report ID=“1xFF” and the data size is 64 bytes (including one byte report ID) when a succeeding packet exists.

Both the report sizes are 64 bytes, which is the maximum length for each of the reports or packets. Further, the report having the report ID of “0x04” is used in the case that the effective data in this report are 63 bytes or less (including the report ID of one byte) and the packet is the last block of the data to be transferred. The remaining data area is filled up with dummy data and transferred in the data size which is coincident with just 63 bytes. The packet or the report having the report ID of “1xFF” is used in the case that the total data to be transferred are larger than 64 bytes and thus a succeeding packet or report exists.

For example, when it is assumed that data of 156 bytes are transferred from the device driver to the personal computer, firstly the report ID of “1xFF” and data of 63 bytes are transferred. This transmission is repeated twice. Then successively, the report ID of “0x04” and the remaining data of 30 bytes and dummy data of 33 bytes are transferred. The receiving side can recognize that it is the last data by receiving the report ID of “0x04”.

According to the constitution of the embodiment of the present invention described above, since the last block uses the packet of 64 bytes which is the maximum length, a useless idle packet or a useless short packet is not required to be transmitted after the last block.

The maximum length of the report is not limited to 64 bytes. Alternatively, a plurality of the report IDs are used for the maximum data length (data size) other than 64 bytes and it may be constituted that the report ID of “1xFF” has a meaning that the data is larger than the defined maximum size and succeeding data exist.

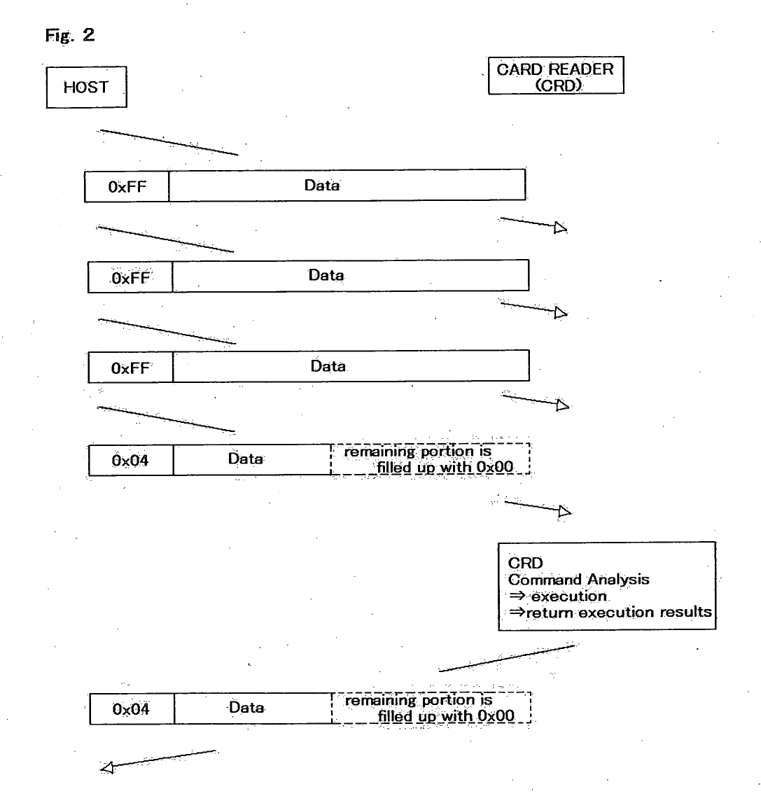

FIG. 2 shows an example for transmitting data of plural packets from the host computer such as a personal computer to the device driver such as a card reader by using two reports which have the report ID of “0x04” and the report ID of “1xFF”.

In FIG. 2, the data to be transmitted includes three packets with the report ID of “1xFF” and one packet with the report ID of “0x04”. The first packet of the three packets to which the report ID of “1xFF” is added is further assigned with “LEN1” and “LEN2” indicating the length of data which follow the report ID, a command “C” and the content of the command “cm” as processing instruction codes, a code “pm” indicating whether or not the data are read from a device, and actual data.

The second packet and the third packet with the report ID of “1xFF” include the report ID of “1xFF” assigned at the head portion of the packet and the data following to the report ID of “1xFF”. In this example, since all the data is not transmitted by using three packets, the rest of the data are transmitted by using the fourth packet. All the data are transmitted by the fourth packet and thus the last report ID is “1x04”. This report ID means that the effective data in this report are equal to or less than 63 bytes and this packet is the last block of the transferred data. In this example, the effective data ends in the midway of the fourth packet. However, the remaining portion is filled up with empty data, for example, the data of “1x00” in order to coincide with the data length that is equal to the report size of the maximum length.

In this way, the data to be transmitted are separated into four packets and transmitted from the host computer to the device driver by the USB communication. The device driver analyzes the commands from the host computer by using the received data, executes the analyzed commands and sends the execution results to the host computer. The packet which returns the execution results to the host computer are assigned with the report ID of “1x04”, “LEN1” and “LEN2” indicating the data length, and the execution result data to the command, and the remaining portion is filled up with the data of “1x00” which is empty data.

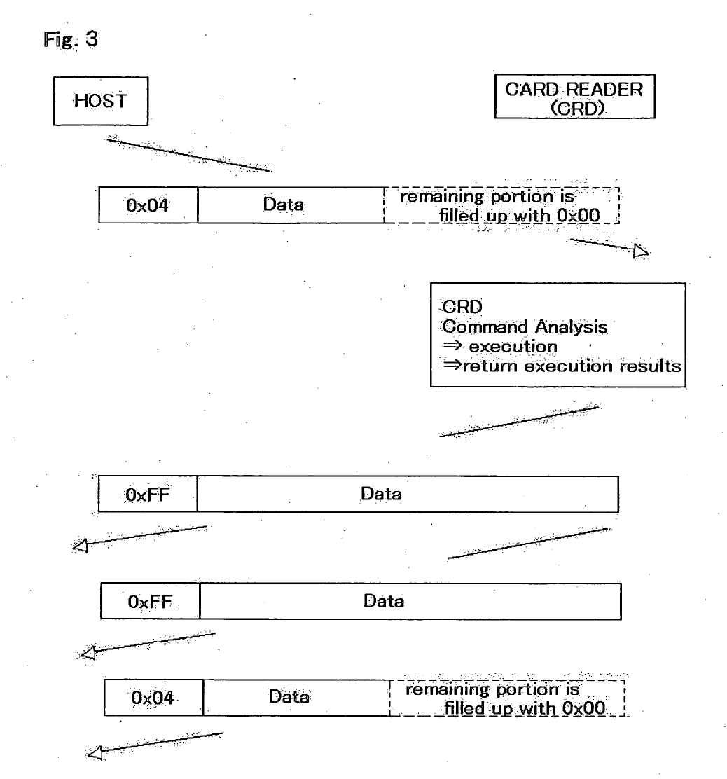

FIG. 3 shows an example for transmitting data of plural packets from the device driver such as a card reader to the host computer. The host computer transmits data including a command to the device driver. In this example, one transmission packet with the report ID of “0x04” is transmitted. This report ID of “0x04” means that the effective data in this report are equal to or less than 63 bytes and this packet is the last block of the transferred data. The packets are assigned with “LEN1” and “LEN2” indicating the data length after the report ID of “0x04”, the execution result data to the command, and the data of “1x00” which is empty data filled up in the remaining portion.

On the device driver side, that is, in a card reader controlled by the host computer, the transmitted packet is received and the command is analyzed, and then the analyzed command is carried out and the execution results are returned to the host computer. In this example, the data to be returned to the host computer consists of two packets having the report ID of “1xFF” and one packet having the report ID of “1x04”. All the data transmission is completed with one packet of the report ID of “0x04”. The remaining portion is assigned and filled up with the data “1x00” which is empty or dummy data. Therefore, the data length is set to be coincident with the report size of the maximum length, which is the same data length as two packets to which the report ID of “1xFF” is added.

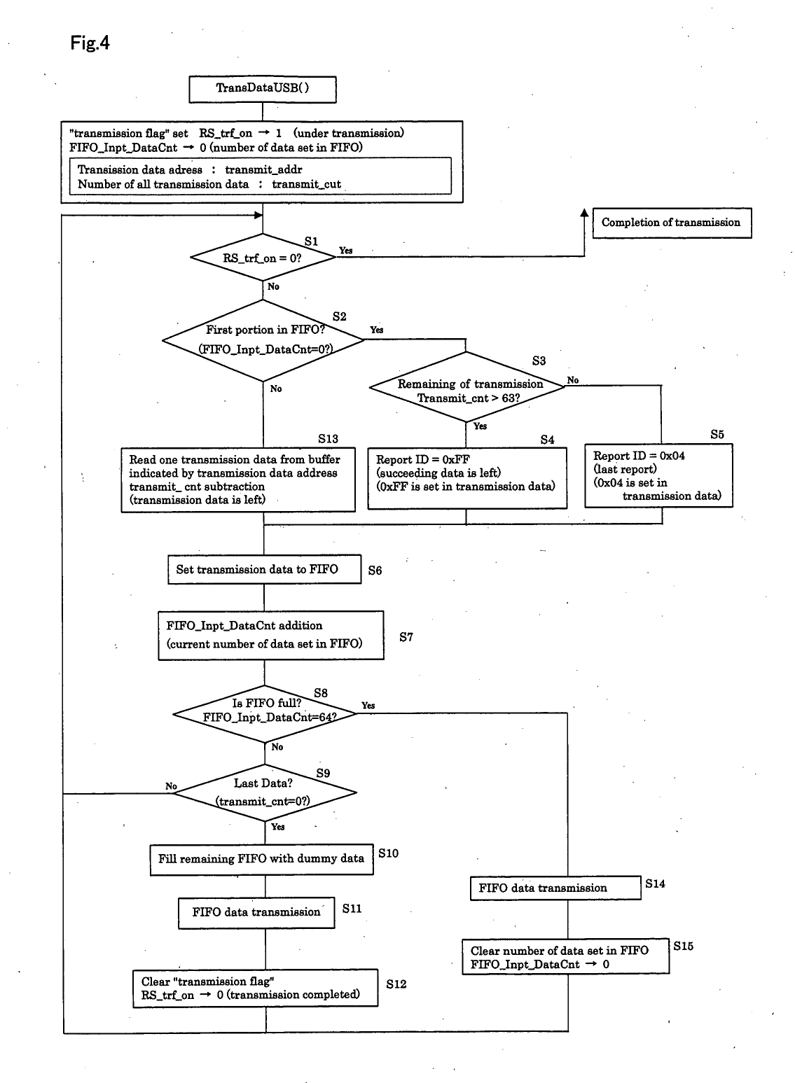

FIG. 4 shows an example of the transmission operating flow when the data are sent from the device driver to the host computer in the embodiment of the present invention described above. Operation steps are shown as S1, S2 or the like.

In step S1, the flag for waiting for the completion of the transmission is checked. The flag “RS_trf_on” indicates whether it is under transmission at present or not, and the “RS_trf_on” of “0” indicates that the transmission is completed and the “RS_trf on” of “1” indicates that the transmission being conducted.

When the flag for waiting for the completion of the transmission is not in the state of the completion of the transmission, that is, “RS_trf_on” is not “0” in step S1, the data to be transmitted is checked to determine whether the data is the first data or not in step S2. In step S2, it is checked whether “FIFO_input_DataCnt” is “0” or not. The “FIFO_input_DataCnt” means the amount of data which is set in an FIFO (first-in/first-out, one kind of a buffer). When the “FIFO_input_DataCnt” is “0”, that is, the amount of data is “0”, it means that the data to be transmitted is to be entered from now. In other words, the data is a head portion (first data) to be set in the FIFO. Therefore, when “FIFO_input_DataCnt” is “0”, the transmission data will enter from now and the data is the first one.

When the data is the first data, that is, “FIFO_input_DataCnt” is “0”, step S3 is conducted and whether the remainder of all the transmission data is more than 63 bytes or not is determined in step S3. In the case that the remainder of the transmission data is more than 63 bytes, the report ID is set to be “1xFF”, that is, the state of “succeeding data are left” is set in step S4. In the case that the remainder of the transmission data is equal to or less than 63 bytes, the report ID is set to be “0x04”, or that “this is the last packet” is set in step S5. In the embodiment of the present invention, the size of one report is the same as that of the FIFO and set to be 64 bytes.

After the report IDs are set as described above, the transmission data is set in the FIFO in step S6, and “1” is added to the “FIFO_input_DataCnt” in step S7 to coincide with the current amount of data which is set in the FIFO. Next, it is determined whether the FIFO is full or not, in other words, whether the “FIFO_input_DataCnt” is equal to “64” or not in step S8. When the FIFO is not full, it is determined whether the data is the last data or not in step S9. In step S9, when the data is not the last data, the operation is returned to step S1. When the data is the last data, the remaining portion of the FIFO is filled up with dummy data in step S10, and the data of the FIFO are sent to the host computer in step S11. Then the “transmission flag” is cleared in step S12, in other words, the flag “RS_trf_on” is set to be “0”, and the operation is returned to step S1. In step S1, since the “transmission flag” is “0”, a transmission completing process is performed.

In step S2, when the data is not the first data of the FIFO, one piece of transmission data is read from the buffer indicated by the transmission data address and the number of the transmission data is subtracted and the remaining data are preserved in step S13 and then the operation in step S6 is performed.

Also, when the FIFO is full in step S8, the data in the FIFO are sent to the host computer in step S14 and the amount of the data which is set in the FIFO is cleared in step S15. In other words, the FIFO_input_DataCnt is set to be “0” and the operation is returned to step S1.

In the above-mentioned embodiment of the present invention, the packet formed by the communication data format includes a report ID that indicates a size of the packet and transmission data. However, the report ID may indicate the size other than the report ID, that is, the transmission data, which also indicates the size of the packet.

As described above, the USB communication method between the host computer and the device driver for the HID specification or the computer system according to the present invention includes determining in advance a communication data format between the host computer and the device driver so that the packet formed by the communication data format includes the report ID that indicates the size of the packet and transmission data, and at the time of transmission, adding the report ID indicating the size to the transmission data at the head portion of the packet and then transmitting the packet with the report ID.

According to the inventions described above, control of data collection on the data reception side can be simplified and the constitution of the communication report is extremely simple. Further, useless processing such as sending an empty packet and a short packet is not required and thus efficient USB communication can be performed.

Alternatively, the USB communication method between the host computer and the device driver for the HID specification or the computer system according to the present invention includes determining in advance the communication data format between the host computer and the device driver so that the packet formed by the communication data format includes the report ID that indicates the presence or the absence of the succeeding packet and transmission data, and at the time of transmission, adding the report ID indicating the presence or the absence of the succeeding packet to the transmission data at the head portion of the packet to be transmitted and then transmitting the packet with the report ID.

According to the embodiments of the invention described above, the constitution of the communication report becomes extremely simple by using the report ID which indicates the presence/absence of the succeeding packet. Therefore, useless processing such as sending an empty packet and a short packet is not required and thus efficient USB communication can be performed.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A universal serial bus (USB) communication method comprising:
determining in advance a communication data format between a host computer and a device driver so that a packet formed by the communication data format includes a report ID that indicates a size of the packet and transmission data;
adding, at a time of transmission, the report ID indicating the size to the transmission data at a head portion of the packet; and
transmitting the packet with the report ID.

2. The USB communication method according to claim 1, further comprising:
preparing in advance a plurality of packets with different predetermined sizes;
selecting a minimum-sized packet from the packets which is capable of accommodating the transmission data; and
transmitting the minimum-sized packet with the report ID.

3. The USB communication method according to claim 2, further comprising:
filling a remaining blank portion of the packet with dummy data when the transmission data has a packet size less than the minimum-sized packet; and
transmitting the minimum-sized packet having a data length of one of the predetermined sizes.

4. The USB communication method according to claim 1, wherein the device driver is a card reader.

5. A universal serial bus (USB) communication method comprising:
determining in advance a communication data format between a host computer and a device driver so that a packet formed by a communication data format includes a report ID that indicates a presence or an absence of a succeeding packet and transmission data;
adding, at the time of transmission, the report ID indicating the presence or the absence of the succeeding packet to the transmission data at a head portion of the packet to be transmitted; and
transmitting the packet with the report ID.

6. The USB communication method according to claim 5, further comprising:
setting in advance, the packet consisting of the report ID and the transmission data to be a predetermined size;
setting in advance, an ID code “presence” which indicates the presence of the succeeding packet and an ID code “absence” which indicates the absence of the succeeding packet;
adding, at the time of transmission, the ID code based on the presence or the absence of the succeeding packet to the transmission data at the head portion of the packet to be transmitted; and
transmitting the packet with the ID code.

7. The USB communication method according to claim 6, further comprising:
filling a remaining blank portion with dummy data in the packet having the ID code “absence”; and
transmitting the packet having a data length of the predetermined size.

8. The USB communication method according to claim 5, further comprising:
providing the driver as a card reader;
adding the ID code to the packet based on the presence or the absence of the succeeding packet at the head portion of the packet to be transmitted, when the packet is transmitted from the card reader to the host computer; and
transmitting the packet with the ID code.

9. A computer system comprising:
a host computer;
a device driver which is in communication with the host computer;
a universal serial bus (USB) communication line for an human interface device (HID) specification which connects the host computer and the device driver; and
a communication data format which is used between the host computer and the device driver and designed so that a packet formed by the communication data format includes a report ID that indicates a size of the packet and transmission data,
wherein, at a time of transmission, the report ID indicating the size is added to the transmission data at a head portion of the packet and the packet with the report ID is transmitted.

10. The computer system according to claim 9, further comprising a plurality of packets with predetermined different sizes, wherein a minimum-sized packet of the packets which is capable of accommodating the transmission data is selected and the minimum-sized packet with the report ID is transmitted.

11. The computer system according to claim 10, further comprising dummy data which are filled in a remaining blank portion of the packet when the transmission data is less than the minimum-sized packet, wherein the minimum-sized packet having a data length of one of the predetermined sizes is transmitted.

12. The computer system according to claim 9, wherein the device driver is a card reader.

13. A computer system comprising:
a host computer;
a device driver which is communicated with the host computer;
a universal serial bus (USB) communication line for a human interface device (HID) specification which connects the host computer and the device driver; and
a communication data format which is used between the host computer and the device driver and designed so that a packet formed by the communication data format includes a report ID that indicates a presence or an absence of a succeeding packet and transmission data;
wherein, at the time of transmission, the report ID indicating the presence or the absence of the succeeding packet is added to the transmission data at a head portion of the packet and the packet with the report ID is transmitted.

14. The computer system according to claim 13, further comprising an ID code “presence” which indicates the presence of the succeeding packet and an ID code “absence” which indicates the absence of the succeeding packet, wherein the packet having of the report ID and the transmission data is set to be a predetermined size and, at the time of transmission, adding the ID code based on the presence or the absence of the succeeding packet to the transmission data at the head portion of the packet to be transmitted and the packet with the ID code is transmitted.

15. The computer system according to claim 14, further comprising dummy data which are filled in a remaining blank portion in the packet having the ID code “absence”, wherein the packet having a data length of the predetermined size.

16. The computer system according to claim 13, wherein the device driver is a card reader, and when the packet is transmitted from the card reader to the host computer, the ID code is added to the packet based on the presence or the absence of the succeeding packet at a head portion of the packet to be transmitted and the packet is transmitted with the ID code.

17. The USB communication method according to claim 1, further comprising determining the size of the packet as a number of bytes.

18. The USB communication method according to claim 5, further comprising determining the size of the packet as a number of bytes.

19. The computer system according to claim 9, wherein the size of the packet is determined as a number of bytes.

20. The computer system according to claim 13, wherein the size of the packet is determined as a number of bytes.
